(19) United States
(12) Patent Application Publication
(10) Pub. No.: US 2015/0248569 A1
(43) Pub. Date: Sep. 3, 2015

(54) Advanced System for Navigating Between, Locating and Monitoring Underground Assets

(71) Applicant: Berntsen International, Inc., Madison, WI (US)

(72) Inventor: William C. Rushing, Sun Prairie, WI (US)

(21) Appl. No.: 14/636,544

(22) Filed: Mar. 3, 2015

Related U.S. Application Data
(60) Provisional application No. 61/947,030, filed on Mar. 3, 2014.

(51) Int. Cl. G06K 7/10

(52) U.S. Cl. CPC G06K 7/10158; G06K 7/10366

(57) ABSTRACT

A marker for underground assets employs a long life battery to provide an active mode for recording data from a sensor or the like and/or for boosting transmissions after being activated by an interrogation signal, the long life battery greatly increasing the range of such underground markers. In some embodiments, the marker antenna may be automatically tuned for different environmental conditions of the underground marker. A field unit for locating the marker may provide for dead reckoning ability in the absence of reliable radio location.

### CROSS REFERENCE TO RELATED APPLICATION

This application claims the benefit of U.S. provisional application 61/947,030 filed Mar. 3, 2014, and hereby incorporated by reference

### BACKGROUND OF THE INVENTION

The present invention relates to RFID-type markers for underground assets and in particular to a system providing improved location of the markers under adverse environmental circumstances and monitoring of the assets.

Underground assets can include a tangled maze of various buried structures that need to be identified, located or monitored. Common underground assets include, for example, pipes associated with water mains, gas lines or sewers, as well as underground conductors such as wires or optical fiber for transmitting electrical power or data.

It is important to mark the location of underground assets so that they may be located for inspection, maintenance, or avoidance. This may be done by using traditional surveying techniques with information recorded in construction or record drawings, or utility atlas maps. Some types of underground assets, even those that have not been intentionally recorded, may be discovered by sensing properties of the assets using techniques such as ground penetrating radar (GPR), ferromagnetism or conductivity measured at the ground surface by devices such as metal detectors and magnetometers. Such sensing techniques may be augmented by locators, such as strong permanent magnets, that are attached to and/or buried with the underground asset and are designed for ready location using appropriate surface sensing technology. In these cases, confirmation of the identity of the underground asset requires time consuming and costly local excavation for direct inspection of the asset or the marker.

US patent application 2011/0181289 and U.S. Pat. No. 8,947,205, assigned to the assignee of the present invention and hereby incorporated by reference, describe an RFID locating and marking system that uses a strong permanent magnet in combination with a radio frequency identification (RFID) marker, both of which may be incorporated in a housing designed to be buried with the underground asset (either next to the underground asset or at a fixed offset distance). Measurement of the magnetic field is used to guide a fieldworker to the approximate location of the RFID marker, location of which can be confirmed by receiving a signal from the RFID marker triggered by an interrogation signal from a unit held by the fieldworker. Data from the RFID marker may be used to confirm the identity of the located RFID marker and associated underground asset before excavation.

Typically, the RFID tags used in markers for underground asset marking are so-called passive RFID tags that do not require a battery that might expire during long periods of underground storage. Such passive RFID tags, instead, obtain electrical power by scavenging some of the electrical power from the interrogating radio signals that are used to trigger a response from the RFID marker. This electrical power provides sufficient energy for the RFID marker to respond to radiofrequency interrogation with a radiofrequency signal holding data indicating the contained data of the RFID marker.

Most RFID tags hold “read only data” such as a serial number uniquely identifying the RFID marker and providing other marker specific data. In addition, the RFID marker may include a writable portion that allows additional data to be stored on the RFID tag, for example, data providing additional information about the corresponding underground asset. Typically, the storable data is relatively limited, for example, currently amounting to less than 100 bytes. The storable data allows basic information to be recorded about the underground asset, for example, a unique underground asset number and short text description.

U.S. patent application Ser. No. 13/668,465 filed Nov. 5, 2012, assigned to the assignee of the present invention and hereby incorporated by reference, describes a system for indexing a centralized database using the serial number stored on the RFID tag. This centralized database may be accessed wirelessly from the field and in this way allows substantially unlimited data to be associated with a given underground marker.

The marking of underground assets with RFID markers is of critical importance during disasters at times and in environments where reliable wireless communication may not be available and underground markers must be located on expedited basis. At such times, data from a remote database may not be available to field workers. Further, current RFID marker systems rely on wireless triangulation or highly accurate GPS satellite information to provide coarse location information allowing the RFID marker to be located. These radio-based location sources may be unavailable or intermittent.

Many underground assets could benefit from periodic inspection, for example, with respect to deterioration, leakage or damage. RFID markers assist in locating the assets so that they can be uncovered by excavation and inspected. While the RFID markers reduce the cost of excavation by providing a more accurate location, the excavation process is nevertheless expensive and greatly limits the inspection cycle of such assets.

### SUMMARY OF THE INVENTION

In one aspect of the invention, an extremely long life battery is coupled to the RFID marker substantially boosting the amount of data that can be conveyed through RFID protocol without access to remote wireless databases. Battery augmented RFID transmissions also improve the range over which the marker may be found. Both of these features assist in using the RFID marker during times of disaster when wireless location services or communication with a remote database are not available. Greater information can be contained directly in the RFID marker and the improve transmission range allows it be located when exact surface position coordinates are difficult to determine.

By providing the RFID marker with a long life battery, active sensors and a computer can be placed on the RFID marker to be associated with the underground assets providing the ability to log data without the need to excavate the asset. Active sensors can also provide important information to emergency workers, for example, of damage or leakage, before excavation is attempted.

In another aspect of the invention, a marker locator used to locate the RFID markers may provide a dead reckoning mode to supplement standard wireless location techniques including GPS and wireless triangulation when wireless signals are blocked or unavailable. This dead reckoning system may make use of non-radio-based location sensing techniques incorporated into the marker locator.

Specifically, the first embodiment of the invention provides an asset marker having a sealable housing adapted for burial in the ground. The housing holds a battery, a nonvolatile memory, and a radio transponder, the latter for receiving an interrogating radio signal and replying thereto with a data transmission radio signal. The radio transponder works in a first passive mode to scavenge energy from the interrogating radio signal to monitor the same and in a second active mode to employ power from the battery in transmitting the data transmission signal in response to the interrogating radio signal. A processor communicating with the radio transponder executes a stored program to transmit data from the nonvolatile memory in the data transmission signals.

It is thus a feature of at least one embodiment of the invention to provide an underground marker for long-term storage that provides improved transmission range and sensing capabilities.

The radio transponder may employ the scavenged energy in the passive mode to transmit a data transmission signal in response to the interrogating radio signal.

It is thus a feature of at least one embodiment of the invention to provide an underground marker that can operate in two modes, either passively scavenging energy for transmitting data or, when available, using power from a long-term battery.

The battery may be selected from the group consisting of a lithium thional chloride battery and a betavoltaic battery.

It is thus a feature of at least one embodiment of the invention to make use of the battery pack that can reasonably offer the necessary life to monitor underground assets where battery replacement is not an option.

The asset marker may include at least one electrical sensor receiving power from the battery and the data transmission signals may include data from the electronic sensor in the second active mode.

It is thus a feature of at least one embodiment of the invention to provide an underground asset tagging that can actively log data during its life even when scavenged energy is not available.

The electronic sensor may be selected from the group consisting of: a gas sensor, corrosion sensor, galvanic sensor, duration-of-wetness sensor, temperature sensor, and humidity sensor.

It is thus a feature of at least one embodiment of the invention to provide sensing of important metrics for a wide variety of underground assets.

The processor may execute the stored program to periodically record data from the electronic sensor in a memory.

It is thus a feature of at least one embodiment of the invention to provide episodic data logging to conserve power.

The processor may enter into a sleep state periodically to be awakened by a timer or by receipt of interrogating radio signals.

It is thus a feature of at least one embodiment of the invention to provide low power consumption when data logging is not required but also provide responsive transmissions at any time even when the processor has not been awakened from the sleep state by the timer.

The memory may be volatile memory.

It is thus a feature of at least one embodiment of the invention to permit the use of memory that requires battery power to retain data.

The asset marker may include a permanent magnet adapted to be sensed through the earth when the asset marker is buried therein.

It is thus a feature of at least one embodiment of the invention to provide a passive method of location of the RFID marker that does not require power consumption by the RFID marker.

The asset marker may include a first and second antenna, the first antenna for receiving the interrogating radio signal and transmitting the data transmission radio signal, and the second antenna for receiving energy for charging the battery through a battery charging circuit.

it is thus a feature of at least one embodiment of the invention to provide a provision for recharging the battery in situ through the use of a special power transfer antenna.

The second antenna may be tuned to a frequency lower than the first antenna.

It is thus a feature of at least one embodiment of the invention to provide a power reception antenna optimized for transmission through the earth when data communication is not required.

In a second embodiment, the invention may provide a sealable housing adapted for burial in the ground, the housing holding an antenna and a radio transponder communicating with the antenna for receiving an interrogating radio signal and replying thereto with a data transmission radio signal. An automatic tuning circuit responsive to electrical loading by the ground to change the tuning of the antenna to match the antenna's impedance to the radio transponder for a range of different electrical loading by the ground.

it is thus a feature of at least one embodiment of the invention to provide an improved underground asset marker with enhanced transmission capabilities through the use of an adaptive antenna that responds to different environmental conditions such as ground moisture for earth composition.

The antenna may include a variable impedance element and the automatic tuning circuit may change the variable impedance element in response to measurement of electrical loading effects.

It is thus a feature of at least one embodiment of the invention to provide a circuit for active antenna tuning that may accommodate a wide variety of environmental conditions.

In the third embodiment, the invention also provides a marker locator unit having both a radio-based location sensor and a non-radio-based location sensor. The marker locator unit also includes an electronic memory holding a spatial location of a field marker, an RFID reader, and a user interface for receiving data from a user and displaying data to a user. A processor communicates with these components to operate in a first mode to read the non-radio-based location sensor to identify a relative location of a field marker holding an RFID circuit and, in a second mode, to read the radio-based location sensor to identify the relative location of a field marker holding an RFID circuit; in each mode a program provides an indication of the relative location to the user interface and when the marker locator unit is proximate to the location, interrogates the RFID circuit to obtain data stored in the field marker.

It is thus a feature of at least one embodiment of the invention to provide a marker locator unit that can operate in the absence of reliable radio-based location services such as GPS or cell tower triangulation to assist field personnel in locating underground assets.

The non-radio-based location sensor may be selected from the group consisting of: an accelerometer, a compass, and a gyroscope.

It is thus a feature of at least one embodiment of the invention to provide “dead reckoning” type sensors that can operate without external support, for example, in disaster areas.

The identification of the location in the first mode may sense steps by a user of the marker locator unit operating in the mode of a pedometer.

It is thus a feature of at least one embodiment of the invention to provide a simple and robust method of range determination for field personnel to underground assets.

The processor may communicate with the user interface to provide a map output having a cursor showing a current user location and the relative location of the field marker as indicated with respect to the current user location in both the first and second modes.

It is thus a feature of at least one embodiment of the invention to provide a contextual understanding of the location of the asset markers that may make use of a prestored or downloaded map.

The processor may determine a relative location at least in part from data received from the RFID marker.

It is thus a feature of at least one embodiment of the invention to permit asset markers to be used to update and correct a dead reckoning navigation system for improved reliability.

These particular objects and advantages may apply to only some embodiments falling within the claims and thus do not define the scope of the invention.

### BRIEF DESCRIPTION OF THE DRAWINGS

FIG. 1 is a simplified diagram of a marker locator being used by an operator to locate an underground asset tagged with an RFID marker, the marker locator such as may include sensors for dead reckoning, and the RFID marker such as may include a supplementary long life battery;

FIG. 2 is a flowchart of the operation of the RFID marker in responding to an RFID interrogation and in performing data logging;

FIG. 3 is a simplified plot of acceleration data received by the marker locator in dead reckoning between points of confirmed location overlaid on a deduced position;

FIG. 4 is a figure similar to that of FIG. 1 showing a special charging circuit providing a low frequency oscillating electromagnetic wave for recharging the batteries of the marker locator in some embodiment; and

FIG. 5 is an expanded view of the RFID marker of FIG. 1 showing an auto-tuning circuit for accommodating changes in ground dielectric conditions.

### DETAILED DESCRIPTION OF THE PREFERRED EMBODIMENT

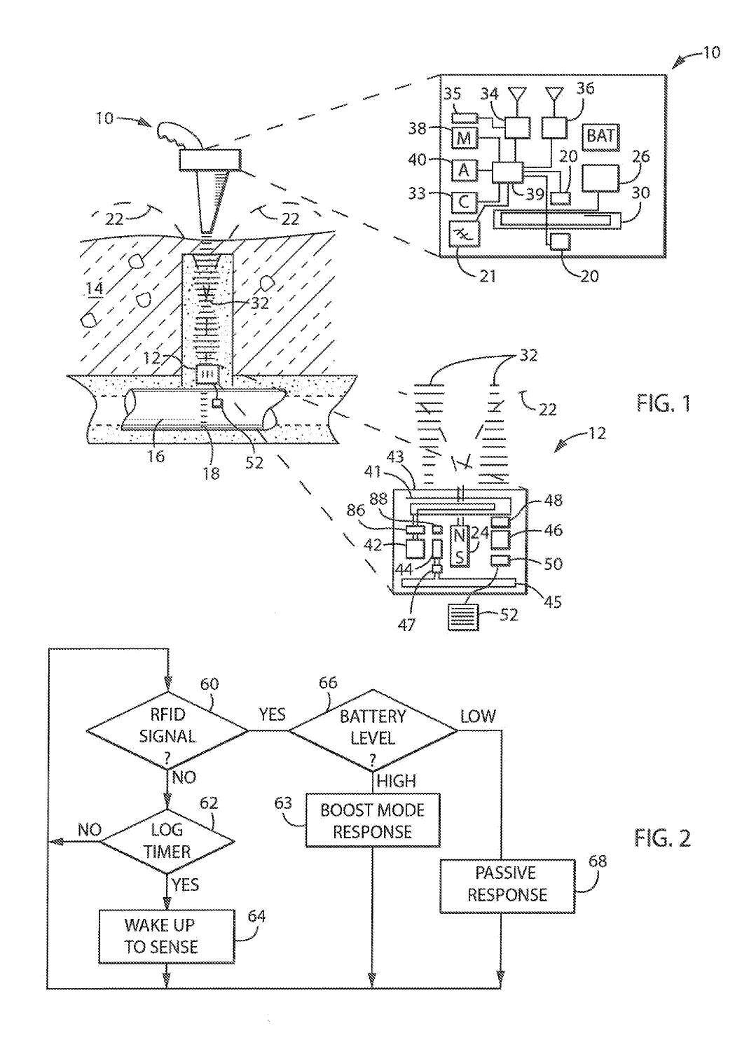

Referring now to FIG. 1, a marker locator unit 10 may be used to locate RFID marker 12 buried in the ground 14, for example, near an underground asset 16 such as a pipe. In one example, the RFID marker 12 may be placed near a pipe weld 18 and may provide monitoring of the weld integrity as will be described.

The marker locator unit 10 provides for one or more magnetic sensors 20, for example, flux gate sensors, for sensing a magnetic field 22 of a magnet 24 on an RFID marker 12 when the latter is positioned near an underground asset 16. Magnetic sensors 20 suitable for the present invention are described in co-pending US patent application 2011/0181289 cited above and for example, may incorporate magnetic sensing technology commercially available from Schonestedt Instrument Company of Kearneysville, W. Va. These magnet sensors 20 may be distinguished from compass sensors to be described further below, the latter of which may be oriented for horizontal rather than vertical flux lines sensitivity.

The marker locator unit 10 may also include an RFID transceiver 26 for communicating via antenna 30 with the RFID marker 12 via radio signals 32. Additionally, the marker locator unit 10 may provide a OPS receiver 34 and a cellular transceiver 36 of types generally known in the art for use with standard cell phones, as well as dead reckoning sensors including accelerometer/gyroscope 40 (linear and/or rate gyro) and a three-axis magnetometer 38, for example, the latter providing for compass-like sensitivity to the Earth's magnetic field. The marker locator unit 10 may further include a camera 35 capable of digital still or video recording. Each of these elements may communicate with a processor 39 having a contained in memory for holding a stored program and data, for example, maps. A marker locator unit 10 suitable for use with the present invention may incorporate these and other elements described in US patent application 2011/0181289 filed Jul. 28, 2011, by the assignee of the present invention and hereby incorporated by reference.

The marker locator unit 10 may also include a display 21 for displaying a prestored map under the control of the processor 39 as will be discussed below

Conversely, the RFID marker 12 includes an RFID antenna 41 for communicating with antenna 30 in the marker locator unit 10 by radio signals 32 following the RFID protocol. Antenna 41 may be connected to an RFID transceiver 42 compatible with RFID transceiver 26 for passive or active RFID communication. A microprocessor 46 communicates with the RFID transceiver 42 as well as with a nonvolatile data memory 48 and data logging circuitry 50. The antenna may contain or be associated with a self-tuning circuit including impedance tuning element 86 and tuning circuit 88 to keep the antenna from de-tuning in harsh environmental conditions as will be described below.

A long life battery 44 may be incorporated into the RFID marker 12 to provide controllable power to the RFID transceiver 42 for boosting its response to an interrogation signal and to provide power to the microprocessor 46 and data logging circuitry 50. The long life battery 44 may, for example, be a lithium thional chloride battery having a life in excess of 15 years and more typically at least 30 years at low-power usages, for example, as commercially available from Tadiran Batteries, a subsidiary of Saft Groupe SA of France under the trade name of Tadiran TLI series batteries. A compact cell of this type can provide capacity in excess of 200 milliamp hours and more typically 300 mA hours in excess of 15 or more typically 30 years. Other batteries including, for example, a betavoltaic battery providing power from beta electron emissions that occur when a neutron decays, may also be used. In some embodiments, volatile memory may be used as powered by the long life battery 44.

A charging circuit may also be associated with the battery 44 to charge the battery 44 using scavenged energy harvested from the RFID interrogation signal or a special charging circuit including a secondary charging antenna 45 tuned to a different, lower frequency than the antenna 41 for improved power transfer through the earth as will be discussed further below. The secondary charging antenna 45 may connect with a power processing circuit 47, for example, providing a low loss rectifier for converting alternating current into direct current charging of the battery 44.

The data logging circuitry 50 provides instrument-quality amplifiers and an analog-to-digital converter to communicate with a variety of sensors 52 of different designs including, for example, sensors 52 that indicate a break of the pipe or the accumulation of dangerous gases or the like. More generally, the sensor 52 may provide any type of useful sensor including: corrosion sensors 52 that may be applied to an underground asset 16 such as may include galvanic sensors, time-of-wetness (TOW) sensors, temperature sensors, humidity sensors and the like. The microprocessor 46 may provide for a low power-drain sleep mode to be awakened periodically by a low-power clock and/or by an interrupt signal generated by the RFID transceiver 42, as will be described below, when the RFID transceiver 42 receives an interrogation radio signal 32. The low-power clock may await the microprocessor 46 for periodic data logging from the sensors 52 and then return the microprocessor 46 to a sleep state for power conservation. The interrupt signal allows the microprocessor 46 to respond immediately to interrogation by the marker locator unit 10.

The RFID marker 12 may include a strong permanent magnet 24, for example, as described in US patent application 2010/0295699 assigned to the assignee of the present invention and hereby incorporated by reference. The strength of the magnet 24 is sized to be readily detectable through multiple feet of overlying earth as will be discussed.

The above-described components of the RFID marker 12 may be contained in a sealable housing 43 designed to seal out moisture and to survive prolonged burial and the pressures of overlying earth.

Referring now to FIG. 2, the RFID marker 12 may normally stay in a low power consumption mode essentially operating as a passive RFID responder determining, at decision block 60, whether an RFID signal has been received. If no RFID interrogation signal has been received, at decision block 62, a logging interval timer (for example, internal to the microprocessor 46) is checked to see if it is time to acquire and log additional data from sensor 52. The sample intervals for data logging may be, for example, separated by days, weeks, or months to provide for extremely low average power consumption in the RFID marker 12.

If the logging interval timer is not expired, the program loops back to decision block 60. Both decision block 60 and decision block 62 are extremely low power consumption processes that can be supported by the battery 44 for in excess of 20 years.

If at decision block 62, the sample interval has expired, then at process block 64, a sample is taken by the data logging circuitry 50 of one or more sensors such as corrosion sensor 52. The data sampled may be stored in the nonvolatile memory 48 in time sequence either in linear fashion or in a circular buffer of a predetermined number of days, months, or years long. This sampling process momentarily wakes the microprocessor 46 and data logging circuitry 50 to perform the necessary data conversion and transfer data from the sensor 52 to the memory 48.

The data logging may be suspended if a measurement of the battery 44 indicates a predetermined level of discharge so as to reserve battery power for acquisition and communication of current data when an RFID pulse is first received.

If at decision block 60, an RFID interrogation signal is received from the marker locator unit 10, then at decision block 66, the strength of the battery 44 is determined (for example, by battery voltage or history of battery usage). If the battery is insufficiently charged to provide for boosted RFID response from the RFID marker 12 (using amplified radio signals 32), the RFID marker 12 works off of the scavenged power from the received radio signals 32 of the RFID interrogation signal to provide a minimal response to the field marker locator unit 10 according to standard passive RFID protocols. This minimal response limits the amount of data returned to the marker locator unit 10 to as little as a serial number of the RFID marker 12.

In the event that the battery 44 cannot provide a boosted RFID response, data of the memory 48 may still be recovered by physical extraction of the RFID marker 12 and connection to a data port protected inside the housing of the RFID marker 12.

If at decision block 66, the battery 44 shows sufficient power to respond in a boosted RFID mode, an additional current data sample is obtained from sensors 52 and broadcast with battery boosted radio signals 32 to the marker locator unit 10 per process block 63. Such boosted radio signals 32 can substantially increase the acquisition distance of RFID signals by the marker locator unit 10. At full battery power, the entire contents of the memory 48, including many samples of data, may be transmitted and more extensive active communication conducted with respect to the marker locator unit 10.

When the voltage of the battery 44 is between levels of fully charged and fully discharged, a priority maybe given to either sampling of sensor data or boosting of RFID response pulses as determined by the user.

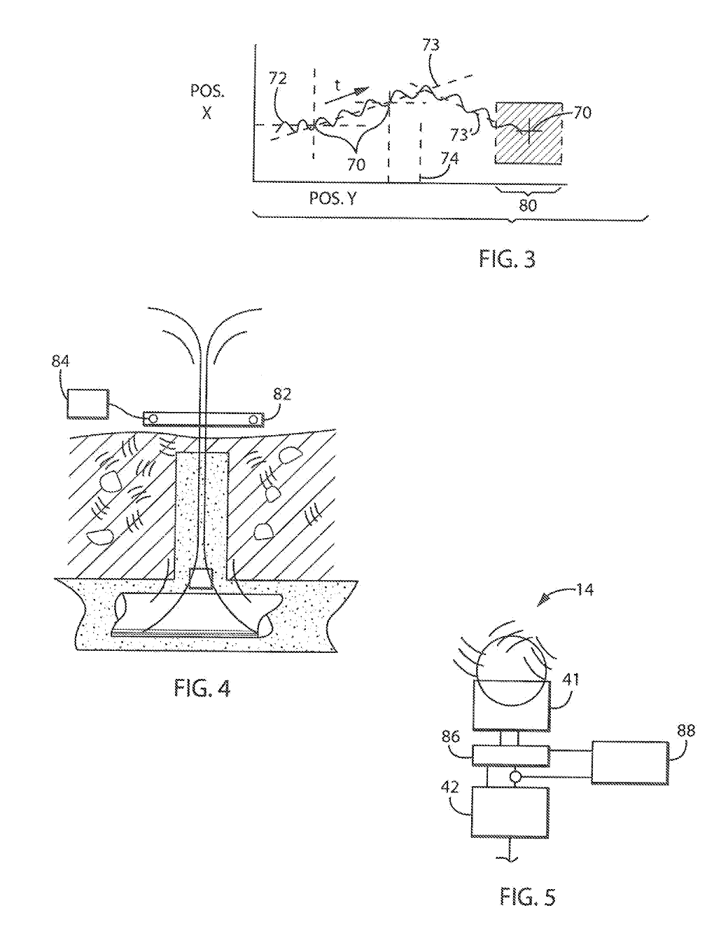

Referring now to FIGS. 1 and 3, generally the GPS receiver 34 may be used to accurately locate the marker locator unit 10 to a sufficient degree to allow detection of the magnetic field 22 and acquisition of the RFID marker 12 by an RFID response. When GPS data is unavailable, GPS receiver 34 may be supplemented by cell tower triangulation using the cellular transceiver 36. Reduced identification information received from the RFID marker 12 when the battery 44 is low may be supplemented by a remote database indexed according to identification information from the RFID marker as described, for example, in U.S. patent application Ser. No. 13/668,465 described above.

In the event that location information from either GPS receiver 34 or cellular transceiver 36 (radio-based location sensors) is lost or sporadic (for example, because of weather, power loss, or an intervening structure or wreckage) the microprocessor 27 may move into a dead reckoning mode. In dead reckoning mode, any previous contemporaneous confirmed location samples 70 (obtained by GPS or wireless triangulation or manual entry, or encoded in a last interrogated RFID marker 12) may be used with non-radio-based location sensors including, for example, a pedometer sensor implemented using the accelerometer/gyroscope 40, or an inertial guidance sensor using the accelerometer/gyroscope 40 and the magnetometer 38 or compass 33 to guide a fieldworker to the next RFID marker 12. In one example an acceleration recording 72 indicates minor acceleration perturbations associated with a user's stride to calculate a stride length. This allows traversal distance of the marker locator unit 10 to be determined in the manner of a pedometer.

If the last two confirmed location samples 70 occur within a predetermined time interval of each other, for example, less than 60 seconds, a heading 73 may be deduced by a straight-line extrapolation between the samples 70 and this heading compared to a magnetic reading by the magnetometer 38 or the gyro of the accelerometer/gyroscope 40 to determine a dead reckoning direction. Alternatively, bearings may be obtained for example by compass 33.

Subsequent course corrections 74, indicated by a change in the reading of the magnetometer 38 or a rate gyro or a sporadic GPS or cell phone reading, can be used to plot a new dead reckoning trajectory or correct this position. Upon arriving at each marker 12, the marker may provide updated location information, as recorded in the marker 12 at the time of installation, correcting error from the dead reckoning and may provide the distance to the next marker and its bearing. Image triangulation using stored images of the environment may also be used for dead reckoning.

The current position of the marker locator unit 10 and known positions of various markers 12 as recorded on a stored map may be displayed to the fieldworker on the display 21 together with stored images to revive for confirmation of the field worker's location.

Generally it will be appreciated that the ability to work with dead reckoning permits the system to be used in locating underground asset points (locations of interest) and mapping underground structures such as tunnels containing assets. Turns, lateral(s), any changes in elevation, and any other feature(s) can also be located and accurately mapped and can be displayed on the display 21, for example, in orthographic or perspective form.

It will be appreciated that the system described above may be used for providing a continuous video stream and/or location point of interest photo recording via the camera 35 that may offer a visual record of a tunnel or underground structure (i.e. a “tunnel view/tunnel vision” of the underground or interior structure passage similar to the Google street view concept), with x, y, z coordinates for each location of interest (valves, laterals, ladders, steps, etc.). Wireless communication in this or other contacts may be provided by an RF link with a radio frequency capable of penetrating wet or dry soil, concrete, or building materials. With such a link, the system provides the capability of showing personnel in a tunnel via the RF link the current x, y, z (latitude, longitude, depth) superimposed on a pre-stored or downloaded digitized map displayed on a hand held computer device such as an Android or Nexus tablet. Such location contemplates determining the x, y, z coordinates of a buried radio device and positively identifying its position on a digitized map and/or transmitting positively identified asset x, y, z coordinates to a cloud based data system via RF link. In an emergency, and the absence of RF links, a computer-aided map may augment the marker system by showing the most recent data available from the data base memory for the asset cluster or any single marker for the area in question.

The invention further contemplates that it may be used to record asset data including x, y, z coordinates on an RFID marker that remains at the location of interest recorded for future reference in the absence of outside RF links capable of penetrating soil, concrete, or other material. In the absence of an accurate map of buried structures, the system may collect locations of interest to form an accurate map of the locations of interest recorded yielding an accurate as-built map of the underground structure. Location information inherent in marked, buried structures can be augmented by any available navigational information.

When the user is close to the RFID marker 12 and in the presence of a strong magnetic field from magnet 24 as indicated by zone 80, the magnetic portion of the dead reckoning may be disabled. This state may be determined, for example, by detecting a vertical magnetic field in excess of a predetermined amount, and the disabling prevents erroneous dead reckoning information in the vicinity of the RFID marker 12.

When the RFID marker 12 is identified, it may hold a recorded location that may be used to provide a new confirmed location sample 70. Thus, finding one RFID marker 12 can provide guidance with respect to finding each successive RFID marker 12. In the presence of many RFID markers (a “cluster” of markers), a marker finder feature may be programmed into the marker locator unit 10 to select/read only the desired unique serial-numbered RFID device from the many available. During dead reckoning or normal navigation, the marker locator unit 10 may act like a “Geiger counter” direction finder, and emit a special tone to guide the technician to the precise desired RFID marker location out of the many available in a “cluster”. A cluster of tags can also be indicated on the map by special icons or other visual, sensual (vibration) or audible aids.

It will be appreciated that the system described may be used to guide a user, for example, underneath blocking structures for a distance to aid in locating and monitoring underground assets when wireless communication is unavailable or intermittent. It will be appreciated that these features may also assist in using the RPM tags, for example, in above ground locations or in areas such as tunnels or mines where wireless communication is normally unavailable. The system can be used like “electronic bread crumbs” by providing multiple RFID markers 12 at short intervals to guide advance or retreat to a desired location of an underground asset in the absence of external mapping or navigational aids. In this application, each marker 12 indicates whether it is an asset marker or not, the latter function being simply to guide a user to another nearby asset marker. In this case, the non-asset marker RFID markers 12, that is the RFID markers 12 that are not associated with an underground feature, can provide guidance information with respect to a next non-asset marker RFID marker 12 or an asset marker RFID marker 12. Location-bearing information can be conveyed, for example, by a polarized RFID signal having a greater strength in the particular orientation as detectable by the marker locator unit 10 or by orienting the magnet 24 to produce a slight a horizontal vector of the magnetic field produced by the magnet 24 that indicates by polarity and axis a bearing angle. Distance information to a next RFID marker 12 may be included in the information encoded in the RFID marker. Alternatively the successive non-asset markers may simply provide coordinates that correct any accumulating error in the dead reckoning system which provides direction and bearing.

Referring now to FIG. 4, additional power can be provided to the RFID marker 12 when buried in the ground 14 through the use of a charging circuit, for example, comprising a surface positioned Helmholtz coil 82 driven by a low-frequency high power source 84 that can provide for radio waves that advantageously penetrate the ground but are less suitable for data transmission because of their low frequency. These radio waves may be received by a specially tuned antenna 45 (shown in FIG. 1) and rectified for charging of the battery 44. This technique may be used to revive shorter-term rechargeable batteries or to provide additional power to the RFID marker 12 for particular monitoring tasks that may require a high-power signal in the absence or presence of a battery.

Referring now to FIG. 5, the RFID transceiver 42 may be connected to the RFID antenna 41 through an impedance-tuning element 86, for example, a varactor connected in parallel to the inductance of the antenna 41 to provide a parallel resonant circuit of the type known in the art. The capacitance of the impedance tuning element 86 may be changed by means of a DC voltage applied to the varactor by a tuning circuit 88, for example, isolated from the radiofrequency signals on the antenna 41 by means of blocking capacitors and chokes as is generally understood in the art. In this way, the tuning circuit 88 may adjust the tuning of the antenna 41 to accommodate detuning of the antenna 41 caused by coupling between the antenna and the dielectric material of the ground 14, such dielectric as may change according to variations in moisture caused by rain or the like or different materials of the ground, for example, sand versus clay.

In one embodiment, the tuning circuit 88 may measure a de-tuning of the antenna 41 by the surrounding dielectric of the ground 14, for example, by analyzing reflected energy from the antenna 41 to the RFID transceiver 42 caused by an impedance mismatch and may change the tuning of the antenna to provide a matching of impedance between the RFID transceiver 42 and the antenna 41 increasing the power transmission of the antenna 41. This feedback nature of the tuning allows automatic corrections to be made for a variety of environmental conditions including fundamental nature of the ground 14.

It will be appreciated that generally the tuning circuit 88 may be constructed to tune the antenna to a resonant peak, reduce reflected power, provide a non-reactive impedance, or match the impedance between the antenna 41 and downstream RFID transceiver 42. In this embodiment, the active tuning may be implemented only after receipt of an interrogation signal from the marker locator unit 10 so as to conserve power, recognizing the fact that the interrogation signal is normally much stronger than the reply signal and therefore can compensate for some antenna mismatch.

In an alternative embodiment, not shown, and interdigital capacitor may be exposed to the ground 14 so that its capacitance changes as a function of the environment to affect a similar but open loop tuning-correction property.

It will be appreciated that the present invention contemplates use with a variety of underground assets including those described above and further includes underground building foundations, tunnels, valve rooms or other structures, surveying markers accidentally or intentionally buried for identification or protection, as well as unused or abandon structures that nevertheless may need to be avoided or located in the future.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

We claim:

1. An asset marker comprising:
a hermetic housing adapted for burial in the ground;
a battery;
a nonvolatile memory;
a radio transponder for receiving an interrogating radio signal and replying thereto with a data transmission radio signal, the radio transponder working in a first passive mode to scavenge energy from the interrogating radio signal to monitor the same and in a second active mode to employ power from the battery in transmitting the data transmission signal in response to the interrogating radio signal; and
a processor communicating with the radio transponder and executing a stored program to transmit data from the nonvolatile memory in the data transmission signals.

2. The asset marker of claim 1 wherein the radio transponder employs the scavenged energy in the passive mode to transmit a data transmission signal in response to the interrogating radio signal.

3. The asset marker of claim 1 wherein the battery provides a capacity in excess of 200 milliamp hours for at least 15 years.

4. The asset marker of claim 3 wherein the battery is selected from the group consisting of a lithium thional chloride battery and a betavoltaic battery.

5. The asset marker of claim 1 further including an electronic sensor receiving power from the battery and wherein the data transmission signals include data from the electronic sensor in the second active mode.

6. The asset marker of claim 5 wherein the electronic sensor is selected from the group consisting of a gas sensor, corrosion sensor, galvanic sensor, duration-of-wetness sensor, temperature sensor, and humidity sensor.

7. The asset marker of claim 5 wherein the processor further executes a stored program to periodically record data from the electronic sensor in a memory.

8. The asset marker of claim 7 wherein the processor enters into a sleep state periodically to be awakened by a timer or by receipt of interrogating radio signals.

9. The asset marker of claim 1 wherein the memory is volatile memory.

10. The asset marker of claim 1 wherein including a permanent magnet adapted to be sensed through the ground when the asset marker is buried therein.

11. The asset marker of claim 1 wherein further including first and second antenna, the first antenna for receiving the interrogating radio signal and transmitting the data transmission radio signal and the second antenna for receiving energy for charging the battery through a battery charging circuit.

12. The asset marker of claim 1 wherein the second antenna is tuned to a frequency lower than the first antenna.

13. An asset marker comprising:
a sealable housing adapted for burial in the ground;
an antenna;
a radio transponder communicating with the antenna for receiving an interrogating radio signal and replying thereto with a data transmission radio signal; and
an automatic tuning circuit communicating with the antenna and responsive to electrical loading by the ground to change the tuning of the antenna to match its impedance to the radio transponder for a range of different electrical loading by the ground.

14. The asset marker of claim 13 wherein the antenna includes a variable impedance element and the automatic tuning circuit changes the variable impedance element in response to measurement of electrical loading effects.

15. A marker locator unit comprising:
at least one radio-based location sensor;
at least one non-radio-based location sensor;
an electronic memory holding a spatial location of a field marker;
an RFID reader;
a user interface for receiving data from a user and displaying data to a user; and
a processor communicating with at least one non-radio-based location sensor, at least one radio-based location sensor, electronic memory, an RFID reader and user interface and executing a program stored in the electronic memory to:
(1) in a first mode, read the non-radio-based location sensor to identify a relative location of a field marker holding an RFID circuit;
(2) in a second mode, read the radio-based location sensor to identify the relative location of a field marker holding an RFID circuit;
(3) provide an indication of the relative location to the user interface; and
(4) when the marker locator unit is proximate to the location, interrogate the RFID circuit to obtain data stored in the field marker.

16. The field marker verification unit of claim 15 wherein the non-radio-based location sensor is selected from the group consisting of an accelerometer, a compass, and a gyroscope.

17. The field marker verification unit of claim 15 wherein the identification of the location in the first mode senses steps by a user of the marker locator unit operating in the mode of a pedometer.

18. The field marker verification unit of claim 15 further including a magnetometer for detecting vertically oriented flux lines from a buried magnet associated with the field marker and wherein the processor executes the stored program to indicate proximity of the field marker from a signal from the magnetometer.

19. The field marker verification unit of claim 15 wherein the processor communicates with the user interface to provide a map output having a cursor showing a current user location, and the relative location of the field marker is indicated with respect to the current user location in both the first and second modes.

20. The field marker verification unit of claim 15 wherein the processor determines a relative location at least in part from data received from the field marker.
